(19) United States
(12) Patent Application Publication
(10) Pub. No.: US 2010/0110292 A1
(43) Pub. Date: May 6, 2010

(54) VIDEO APPARATUS AND METHOD OF CONTROLLING THE VIDEO APPARATUS

(75) Inventors: Sung-bo OH, Suwon-si (KR); Tae-hee Lee, Suwon-si (KR); Young-taek Yoo, Nonsan-si (KR); Hyoung-woo Jeon, Suwon-si (KR); Jae-ho Park, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/609,291

(22) Filed: Oct. 30, 2009

(30) Foreign Application Priority Data
Nov. 5, 2008 (KR) 2008-0109520
May 11, 2009 (KR) 2009-0040777

(51) Int. Cl. H04N 3/27

(52) U.S. Cl. 348/554; 348/E03.049

(57) ABSTRACT

A video apparatus and a method to control the video apparatus thereof. The video apparatus receives information regarding device and functions of the external apparatus from the external apparatus, and transmits information regarding device and functions of the video apparatus to the external apparatus.

### CROSS-REFERENCE TO RELATED APPLICATIONS

This application claims priority under 35 U.S.C. §119(a) from Korean Patent Application No. 2008-109520, filed on Nov. 5, 2008 and Korean Application No. 2009-40777, filed on May 11, 2009, in the Korean Intellectual Property Office, the contents of which are incorporated herein in their entirety by reference.

### BACKGROUND

1. Field of the Invention

The present general inventive concept relates to a video apparatus and a method to control the video apparatus, and more particularly, to a video apparatus to control functions using an A/V interface capable of two-way communication and a method for controlling the video apparatus thereof.

2. Description of the Related Art

With the development of technology regarding a video apparatus, televisions and audio/visual (AV) devices connected to televisions have become increasingly diverse. In particular, a size of a television screen has become larger and more diverse, and different image quality modes may be provided according to different contents such as a movie or a broadcasting program.

As the functions of television have become diverse, and the functions of AV devices connected to televisions have improved, a user can watch an image with higher image quality and higher quality than ever before. In addition, a user can use a home theater system to enjoy a theater-like atmosphere at home.

However, diverse televisions and diverse AV devices connected to televisions have made it more difficult for a user to identify a function of each device and to identify which function provides optimum image quality between the television and the AV device.

A user desires to watch high-quality images, and therefore a method to automatically select appropriate functions for televisions and external AV devices is needed.

SUMMARY

The present general inventive concept provides a video apparatus to receive information regarding an external device and external device function from the external device via an interface, and transmit information regarding the video apparatus and video apparatus function to the external device and a method to control the video apparatus thereof.

The present general inventive concept also provides a video apparatus to transmit information regarding video apparatus and video apparatus functions to an external device via an image signal channel and to receive information regarding the external devices and external device functions from the external device via a data channel of interface and a method to control the video apparatus thereof.

Additional features and/or utilities of the present general inventive concept will be set forth in part in the description which follows and, in part, will be obvious from the description, or may be learned by practice of the general inventive concept.

The foregoing and/or other features and utilities of the present general inventive concept may be achieved by providing a video apparatus connectable to an external apparatus which includes an interface connectable to the external apparatus and a control unit to transmit apparatus and function information of the video apparatus to the external apparatus and to receive device and function information of the external apparatus from the external apparatus, wherein the function information of the video apparatus includes information regarding whether the video apparatus supports a certain function, wherein the function information of the external apparatus includes information regarding whether the external apparatus supports a certain function, and wherein the control unit executes the certain function if the external apparatus and the video apparatus supports the certain function.

The certain function may include functions regarding an image quality mode of an image.

According to the certain function, the video apparatus may receive data of which an image quality is not adjusted from the external apparatus and may adjust an image quality of the image.

In the image quality mode, at least one of resolution, sharpness, brightness, noise reduction, hue, and saturation may be adjusted.

The interface may be high definition multimedia interface (HDMI) interface.

The external apparatus may be received in a source product description (SPD) InfoFrame format, and the function information of the external apparatus may be included in at least one data byte included in the SPD InfoFrame.

The control unit may transmit the information of the video apparatus to the external apparatus in an enhanced display identification data (EDID) format, and may record and transmit the function information of the video apparatus in at least one byte included in the EDID.

The foregoing and/or other features and utilities of the present general inventive concept may also be achieved by providing a method to control a video system in which a video apparatus is connectable to an external apparatus via an interface which includes transmitting apparatus and function information of the video apparatus to the external apparatus, receiving apparatus and function information of the external apparatus, and executing a certain function if the external apparatus and the video apparatus support the certain function, wherein the function information of the video apparatus includes information regarding whether the video apparatus supports the certain function and wherein the function information of the external apparatus includes information regarding whether the external apparatus supports the certain function.

The certain function may include a function related to an image quality mode of an image.

In the executing the certain function, the video apparatus may receive data of which an image quality mode is not adjusted from the external apparatus and may adjust the image quality mode of the image.

The image quality mode may adjust at least one of resolution, sharpness, brightness, noise reduction, hue, and saturation.

The receiving may receive the information regarding device and function of the external apparatus via an image signal channel of the interface, and the transmitting may transmit information regarding device and function of the video apparatus to the external apparatus via a data channel of the interface.

The interface may be high definition multimedia interface (HDMI).

The image signal channel may be a transition minimized differential signaling (TMDS) of the HDMI interface and the data channel may be a display data channel (DDC) of the HDMI interface.

The foregoing and/or other features and utilities of the present general inventive concept may also be achieved by providing an external apparatus connectable to a video apparatus which includes an interface connectable to the video apparatus and a control unit to transmit information regarding apparatus and function of the external apparatus to the video apparatus and to receive apparatus and function information of the video apparatus from the video apparatus, wherein the function information of the external apparatus includes information regarding whether the external apparatus supports a certain function and the function information of the video apparatus includes information regarding whether the video apparatus supports the certain function, and wherein the control unit executes the certain function if the external apparatus and the video apparatus support the certain function.

The certain function may include a function related to an image quality mode of an image.

According to the certain function, the external apparatus data of which an image quality is not adjusted may be transmitted to the video apparatus so that the video apparatus may adjust the image quality mode of the image.

The image quality mode may adjust at least one of resolution, sharpness, brightness, noise reduction, hue, and saturation.

The foregoing and/or other features and utilities of the present general inventive concept may also be achieved by providing a method to control a video system in which an external apparatus is connectable to a video apparatus via an interface which includes transmitting apparatus and function information of the external apparatus to the video apparatus, receiving apparatus and function information of the video apparatus from the video apparatus and executing a certain function if the function information of the video apparatus indicates that the video apparatus supports the certain function and the external apparatus also supports the certain function, wherein the function information of the external apparatus includes information regarding whether the external apparatus supports the certain function, and wherein the function information of the video apparatus includes information regarding whether the video apparatus supports the certain function.

The foregoing and/or other features and utilities of the present general inventive concept may also be achieved by providing a video apparatus which includes an interface to communicate with an external apparatus, and a control unit to transmit a first information of the video apparatus to the external apparatus and to receive a second information of the external apparatus, wherein the control unit executes a certain function if the first information corresponds to the second information.

The first information may include a first device information and a first function information of the video apparatus.

The second information may include a second device information and a second function information of the external apparatus.

The control unit may execute the certain function if the first and second function information support the certain function.

The interface may receive and transmit information signals and image data signals through HDMI interface channels, the information signals may include the first information and the second information, and the information signals may be transmitted between the image data signals.

The foregoing and/or other features and utilities of the present general inventive concept may also be achieved by providing a computer readable storage medium containing a method of controlling a video apparatus connectable to an external device, the method including receiving first device information and first function information of the external device, comparing the first device information and the first function information with a second device information and a second function information of the video apparatus, and transmitting a signal to the video apparatus to execute a certain function when the first function information and the second function information support the certain function.

### BRIEF DESCRIPTION OF THE DRAWINGS

These and/or other features and utilities of the present general inventive concept will become apparent and more readily appreciated from the following description of the exemplary embodiments, taken in conjunction with the accompanying drawings of which:

FIG. 1 is a schematic view of a video system according to an exemplary embodiment of the present general inventive concept;

FIG. 2 is a block diagram illustrating a detailed structure of a television according to an exemplary embodiment of the present general inventive concept;

FIG. 3 is a block diagram illustrating a structure of a BD player according to an exemplary embodiment of the present general inventive concept;

FIG. 4 is a flow chart illustrating a method to control a video apparatus according to an exemplary embodiment of the present general inventive concept;

FIG. 5 is a schematic view illustrating HDMI interface channels in detail according to an exemplary embodiment of the present general inventive concept;

FIG. 6 is a table illustrating information corresponding to data bytes of SPD InfoFrame according to an exemplary embodiment of the present general inventive concept;

FIG. 7 is a schematic view illustrating an example of SPD InfoFrame having information regarding BD player functions according to an exemplary embodiment of the present general inventive concept;

FIG. 8 is a table illustrating information corresponding to EDID bytes in detail according to an exemplary embodiment of the present general inventive concept;

FIG. 9 is a schematic view illustrating an example of an EDID having information regarding television functions;

FIG. 10 is a table illustrating whether a BD wise mode is on or off depending on whether a BD wise mode of TV and BD is on or off; and

FIG. 11 is a schematic view of a video system according to another exemplary embodiment of the present general inventive concept.

### DETAILED DESCRIPTION OF THE EMBODIMENTS

Reference will now be made in detail to the exemplary embodiments of the present general inventive concept, examples of which are illustrated in the accompanying drawings, wherein like reference numerals refer to the like elements throughout. The exemplary embodiments are described below in order to explain the present general inventive concept by referring to the figures.

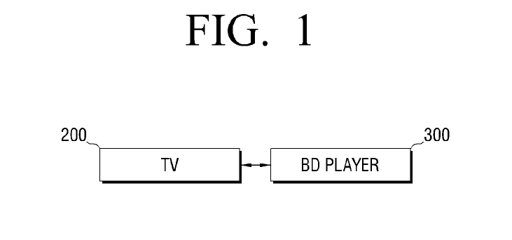

FIG. 1 is a schematic view of a video system according to an exemplary embodiment of the present general inventive concept.

As illustrated in FIG. 1, the video system includes a television apparatus (TV) 200 and a data storing and reproducing apparatus, such as a Blue-ray Disk (BD) player 300 connectable to each other through an interface capable of two-way communication. Although FIG. 1 illustrates the BD player 300 as the data storing and reproducing apparatus, the present general inventive concept is not limited thereto.

The interface connecting the TV 200 with the BD player 300 may be a high definition multimedia interface (HDMI), since HDMI includes a channel capable of two-way communication.

However, the present general inventive concept is not limited thereto. That is, in alternative exemplary embodiments, any A/V interface capable of two-way communication may be applied.

The BD player 300 reads out image and sound signals recorded on the BD and transmits the image and sound signals to the TV 200. Such a device which provides image and sound signals is referred to as a source device based on HDMI standards.

The BD player 300 regularly transmits information regarding the device (such as, the name of manufacturer, model, and etc.) and certain functions (such as, whether an image quality mode is supported) to the TV 200 through an image receiving channel to inform the TV 200 of information regarding the BD player 300 and certain functions that the BD player 300 supports.

In exemplary embodiments, the certain functions include at least one of a function regarding image quality mode of an image or a type of the image source. The examples of functions regarding image quality mode include screen ratio adjustment, brightness adjustment, and scaling. The examples of functions regarding image source include movie mode, news mode, drama mode, and etc. However, the present general inventive concept is not limited thereto.

The TV 200 receives an image signal and a sound signal from the BD player 300 and displays these signals on a display screen. The apparatus which receives image signals and sound signals and displays them on the display screen is called a sink device, based on HDMI standards.

The TV 200 regularly transmits information regarding the device (i.e., device information) such as, the name of manufacturer, model, and etc. and certain functions (such as, whether image quality mode is supported) to the BD player 300 through a data channel to inform the BD player 300 of information regarding the TV 200 and which functions the TV 200 supports. However, the present general inventive concept is not limited thereto.

By sending and receiving their own device information and information regarding certain functions, the TV 200 and the BD player 300 can confirm with each other whether to support a function to provide optimum image quality. In particular, the TV 200 and the BD player 300 can identify whether certain functions are supported based on function information received from each other, and therefore can execute optimum functions for each device.

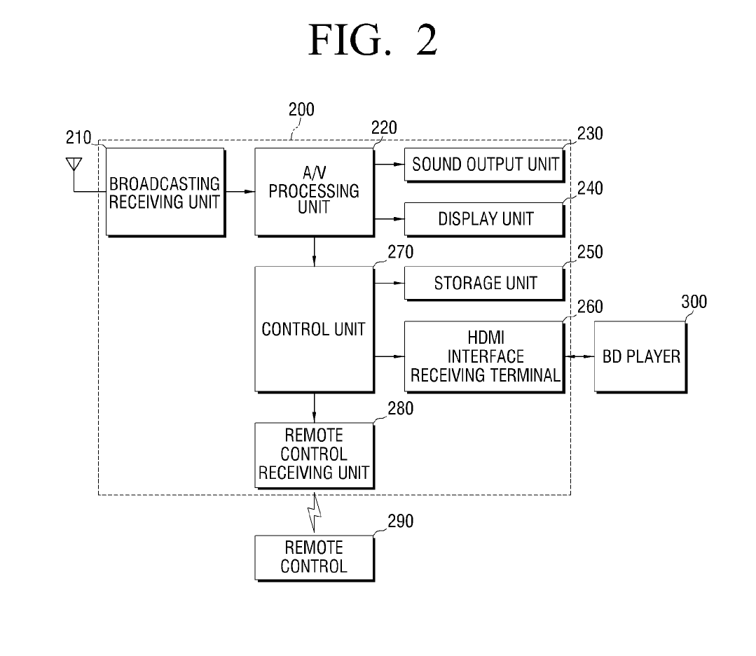

The structure of the TV 200 will be explained in detail with reference to FIG. 2.

As illustrated in FIG. 2, the TV 200 includes a broadcasting receiving unit 210, an A/V processing unit 220, a sound output unit 230, a display unit 240, a storage unit 250, a HDMI interface receiving terminal 260, a control unit 270, and a remote control receiving unit 280.

In exemplary embodiments, the broadcasting receiving unit 210 receives wired or wireless broadcasting from a broadcasting station or a satellite and demodulates the broadcasting. However, the present general inventive concept is not limited thereto.

The A/V processing unit 220 performs a signal processing such as a video decoding, video scaling, or audio decoding on the image signal and sound signal input from the broadcasting receiving unit 210 and the control unit 270. The A/V processing unit 220 output the image signal to the display unit 240, and the sound signal to the sound output unit 230.

The sound output unit 230 outputs the sound output from the A/V processing unit 220 through a speaker (not illustrated).

The display unit 240 displays the image output from the A/V processing unit 220. In particular, the display unit 240 displays an image showing a process of booting the TV 200 on a screen.

The storage unit 250 stores the recorded image. The storage unit 250 may include a hard-disk, non-volatile memory, and flash memory. However, the present general inventive concept is not limited thereto.

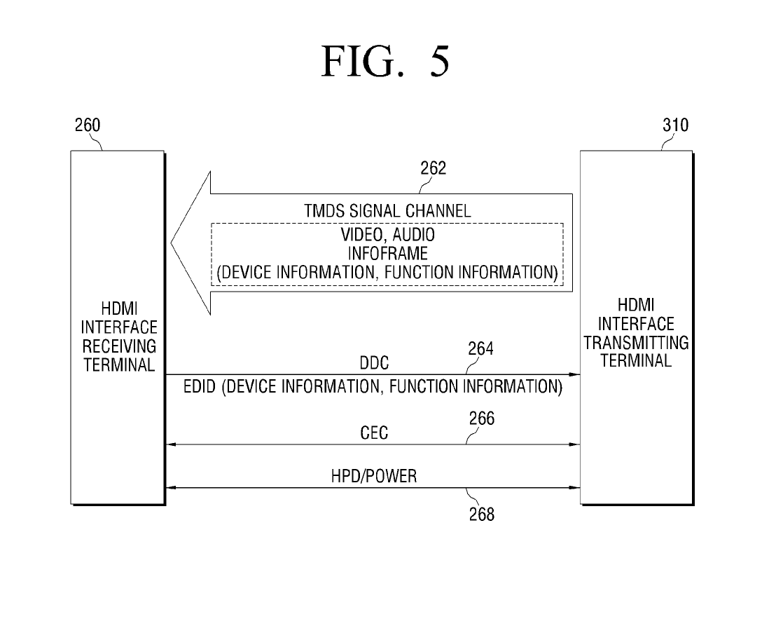

The HDMI interface receiving terminal 260 receives an image signal and a sound signal from the BD player 300 connected via a HDMI cable. The structure of the HDMI interface receiving terminal 260 will be explained in detail with reference to FIG. 5.

The remote control receiving unit 280 receives a command by a user and transmits the command to the control unit 270.

The control unit 270 identifies the user's command based on the manipulation received from the remote control 290, and controls comprehensive operation of the TV 200 according to the identified command.

The control unit 270 receives device information and function information of the BD player 300 from the BD player 300 via the HDMI interface receiving terminal 260. The control unit 270 transmits the device information and function information of the TV 200 to the BD player 300 via the HDMI interface receiving terminal 260.

Since the data channel of the HDMI interface is capable of two-way communication, the control unit 260 transmits the device information and function information of the TV 200 through the data channel of the HDMI interface receiving terminal 260. More specifically, the control unit 260 transmits the device information and function information of the TV 200 through a HDMI interface display data channel (DDC) of the HDMI interface receiving channel 260.

The control unit 270 transmits device information of the TV 200 to the BD player 300 in an enhanced display identification data (EDID) format. The control unit 270 records function information of the TV 200 in at least one byte included in the EDID. Accordingly, the control unit 270 transmits device information and function information of the TV 200 in the EDID format to the BD player 300.

The device information of the TV 200 is system information of the TV 200 or information regarding specification, and includes information such as the name of manufacturer and the name of model of the TV 200. For example, the device information of the TV 200 may be “SAMSUNG”, which is a manufacturer name, and “L3”, which is a model name. However, the present general inventive concept is not limited thereto.

The function information of the TV 200 represents information regarding whether certain functions are supported by the TV 200. The certain functions are functions regarding image quality of an image or the type of image source. In exemplary embodiments, the examples of functions regarding image quality mode include screen ratio adjustment, brightness adjustment, and scaling. In exemplary embodiments, examples of functions regarding image source include movie mode, news mode, drama mode, and etc. However, the present general inventive concept is not limited thereto.

More specifically, the function information of the TV 200 may be recorded in bytes, of which the address is 0Bh in the EDID. If the byte of address 0Bh is 1, that means the TV 200 supports certain functions, and if the byte of address 0Bh is 0, that means the TV 200 does not support certain functions.

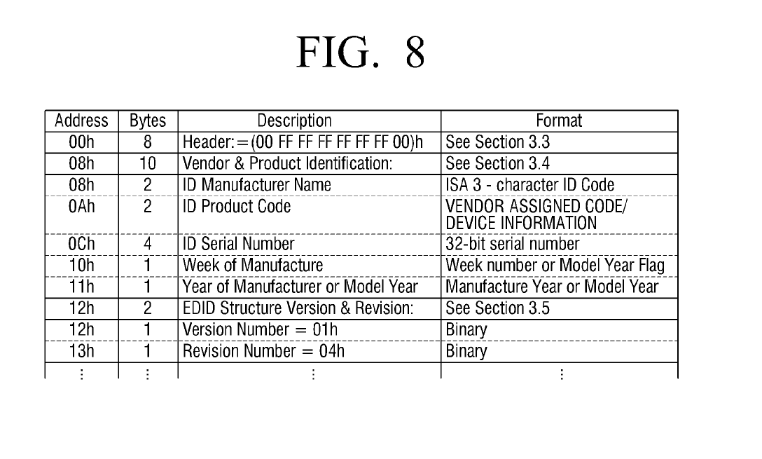

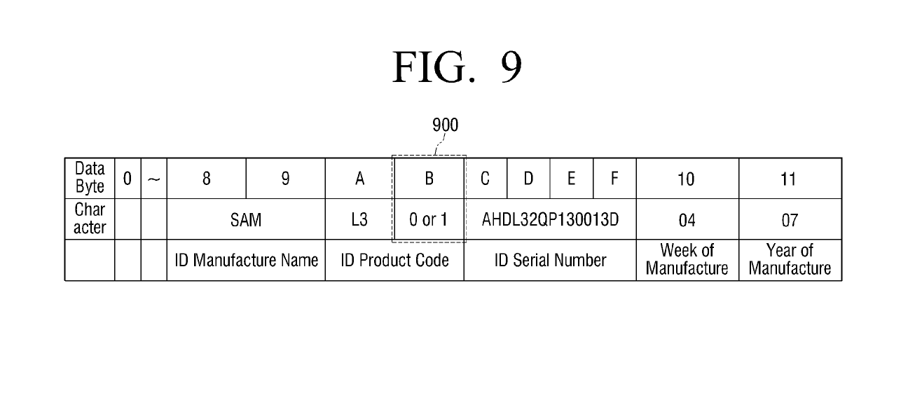

The EDID format including function information will be explained with reference to FIGS. 8 and 9.

The control unit 270 receives device information and function information of the BD player 300 from the BD player 300 through an image signal channel of the HDMI interface receiving terminal 260. The image signal channel may be a transition minimized differential signaling (TMDS) signal of the HDMI interface. However, the present general inventive concept is not limited thereto.

The control unit 270 receives device information of the BD player 300 in a source product description (SPD) InfoFrame format. The function information of the BD player 300 is recorded in at least one byte included in the SPD InfoFrame. Accordingly, the control unit 270 determines whether certain functions are supported by the BD player 300.

The device information of the BD player 300 is system information of the BD player 300 or information regarding specification, and includes information such as the name of manufacturer and name of model of the BD player 300. For example, the device information of the BD player 300 may be “SAMSUNG”, which is a manufacturer name, and “BD-1600”, which is a model name.

The function information of the BD player 300 represents information regarding whether certain functions are supported by the BD player 300. The certain functions are functions regarding image quality of an image or the type of image source. In exemplary embodiments, the examples of functions regarding image quality mode include screen ratio adjustment, brightness adjustment, and scaling. In exemplary embodiments, examples of functions regarding image source include movie mode, news mode, drama mode, and etc. However, the present general inventive concept is not limited thereto.

More specifically, function information of the BD player 300 may be recorded in the 24^{th} byte of the SPD InfoFrame. If the 24^{th} byte is 1, that means the BD player 300 supports certain functions, but if the 24^{th} byte is 0, that means the BD player 300 does not support certain functions.

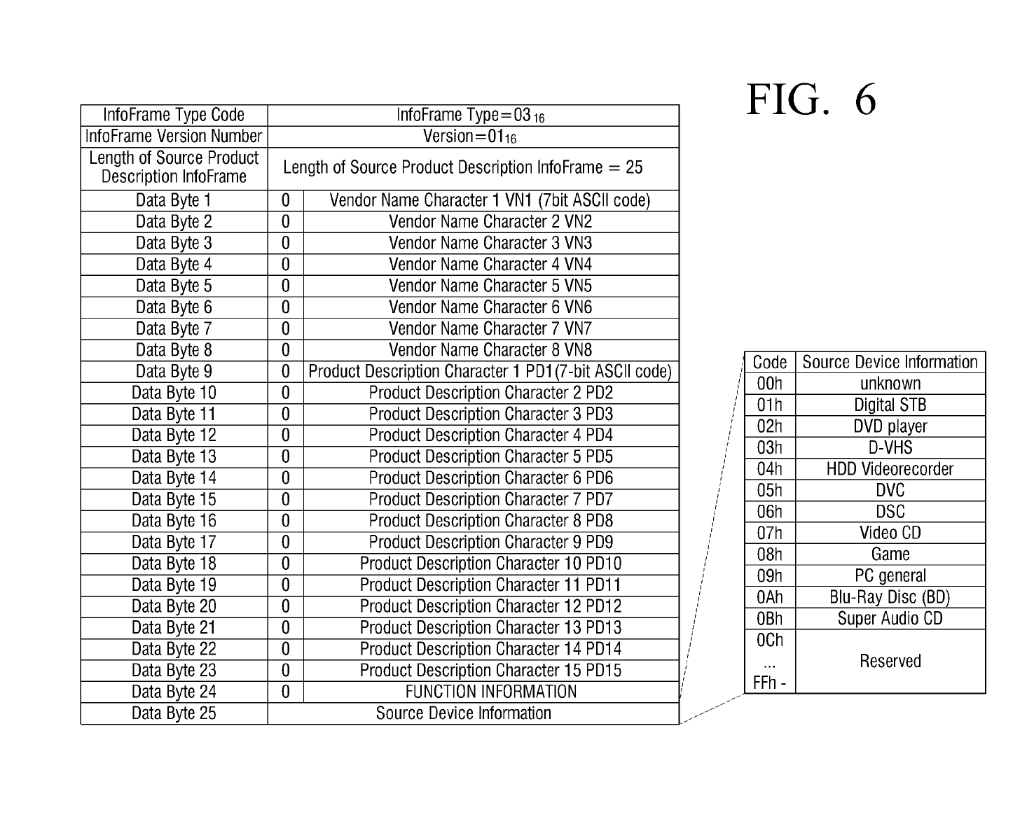

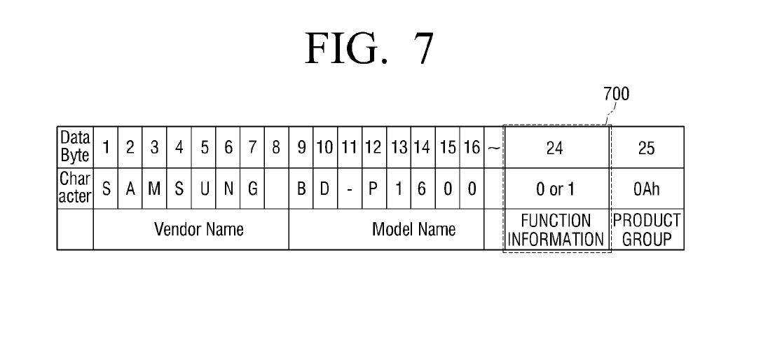

The SPID InfoFrame format including function information will be explained with reference to FIGS. 6 and 7.

If the function information indicates that the BD player 300 supports certain functions and the TV 200 also supports the same certain functions, the control unit 270 executes the certain functions. For instance, if both the TV 200 and the BD player 300 support a wide screen mode, the TV 200 checks function information of the BD player 300 received when the BD player 300 is connected to the TV 200 and executes the wide screen mode.

By receiving function information from the BD player 300, the TV 200 is able to execute optimum functions in combination with the BD player 300. By receiving function information as well as device information of the BD player 300, the TV 200 is able to execute functions appropriate to the BD player 300. As the TV 200 transmits the device information and function information of the TV 200, the BD player 300 is also able to execute functions appropriate to the TV 200.

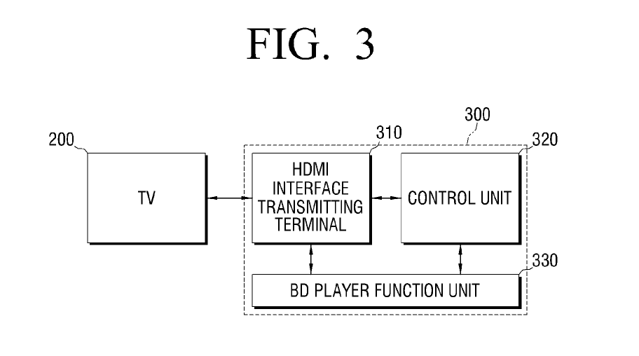

The structure of the BD player 300 will be explained in detail with reference to FIG. 3 FIG. 3, is a block diagram illustrating a structure of the BD player 300 according to an exemplary embodiment of the present general inventive concept. As illustrated in FIG. 3, the BD player 300 includes a HDMI interface transmitting terminal 310, a control unit 320, and a BD player function unit 330.

The BD player function unit 330 executes usual functions as a BD player. For instance, the BD player function unit 330 reads out an image and sound signal of an inserted BD and transmits the signals to the TV 200, which is connected to the BD player.

The HDMI interface transmitting terminal 310 is connected to the TV 200 through a HDMI cable. The HDMI interface transmitting terminal 310 transmits the image and sound signals read out from the BD to the TV 200. The HDMI interface transmitting terminal 310 will be explained in detail with reference to FIG. 5.

The control unit 320 transmits device information and function information of the BD player 300 to the TV 200 through an image signal channel of the HDMI interface transmitting terminal 310. The control unit 320 receives device information and function information of the TV 200 from the TV 200 through a data channel of the HDMI interface transmitting terminal 310.

The image signal channel may be a TMDS signal channel of the HDMI interface and the data channel may be a DDC of the HDMI interface. However, the present general inventive concept is not limited thereto. The function information of the BD player 300 includes information regarding whether the BD player 300 supports certain functions. The function information of the TV 200 includes information regarding whether the TV 200 supports certain functions.

The control unit 320 receives device information of the TV 200 from the TV 200 in the EDID format. The function information of the TV 200 is recorded at least one byte included in the EDID. Accordingly, the control unit 270 receives both device information and function information of the TV 200 from the TV 200 in the EDID format.

The device information of the TV 200 is system information of the TV 200 or information regarding specification, and includes information such as the name of manufacturer and name of model of the TV 200. For example, the device information of the TV 200 may be “SAMSUNG”, which is a manufacturer name, and “BD-1600”, which is a model name.

The function information of the TV 200 represents information regarding whether certain functions are supported by the TV 200. The certain functions are functions regarding image quality of an image or the type of image source of the TV 200. In exemplary embodiments, the examples of functions regarding image quality mode include screen ratio adjustment, brightness adjustment, and scaling. In further exemplary embodiments, the examples of functions regarding image source include movie mode, news mode, drama mode, and etc. However, the present general inventive concept is not limited thereto.

More specifically, the function information of the TV 200 may be recorded in bytes, of which the address is 0Bh in the EDID. If the byte of address 0Bh is 1, that means the TV 200 supports certain functions, and if the byte of address 0Bh is 0, that means the TV 200 does not support certain functions.

The EDID format including function information will be explained with reference to FIGS. 8 and 9.

The control unit 320 transmits device information and function information of the BD player 300 to the TV 200 through an image signal channel of the HDMI interface transmitting terminal 310. The image signal channel may be a transition minimized differential signaling (TMDS) signal of the HDMI interface.

The control unit 320 transmits device information of the BD player 300 in a source product description (SPD) InfoFrame format. The function information of the BD player 300 is recorded in at least one byte included in the SPD InfoFrame. Accordingly, the control unit 320 may transmit function information of the BD player 300 along with device information of the BD player 300 to the TV 200.

The device information of the BD player 300 is system information of the BD player 300 or information regarding specification, and includes information such as the name of manufacturer and the name of model of the BD player 300. For example, the device information of the BD player 300 may be “SAMSUNG”, which is a manufacturer name, and “L3”, which is a model name.

The function information of the BD player 300 is information regarding whether certain functions are supported by the BD player 300. The certain functions include functions regarding image quality mode of an image or the type of image source of the BD player 300. In exemplary embodiments, the examples of functions regarding image quality mode include screen ratio adjustment, brightness adjustment, and scaling. In exemplary embodiments, the examples of functions regarding image source include movie mode, news mode, drama mode, and etc.

More specifically, the function information of the BD player 300 may be recorded in the 24^{th} byte of the SPD InfoFrame. If the 24^{th} byte is 1, that means the BD player 300 supports certain functions, but if the 24^{th} byte is 0, that means the BD player 300 does not support certain functions.

The SPID InfoFrame format including function information will be explained with reference to FIGS. 6 and 7.

If the function information indicates that the TV 200 supports certain functions and the BD player 300 also supports certain functions, the control unit 320 executes the certain functions. For instance, if both the TV 200 and the BD player 300 support a wide screen mode, the BD player 300 checks function information of the TV 200 received when the TV 200 is connected to the BD player 300 and executes the wide screen mode on the TV 200.

By receiving function information from the TV 200, the BD player 300 is able to execute optimum functions in combination with the TV 200. By receiving function information as well as device information of the TV 200, the BD player 300 is able to execute functions appropriate to the type of the TV 200. As the BD player 300 transmits its own device information and function information to the TV 200, the TV 200 is also able to execute functions appropriate to the BD player 300.

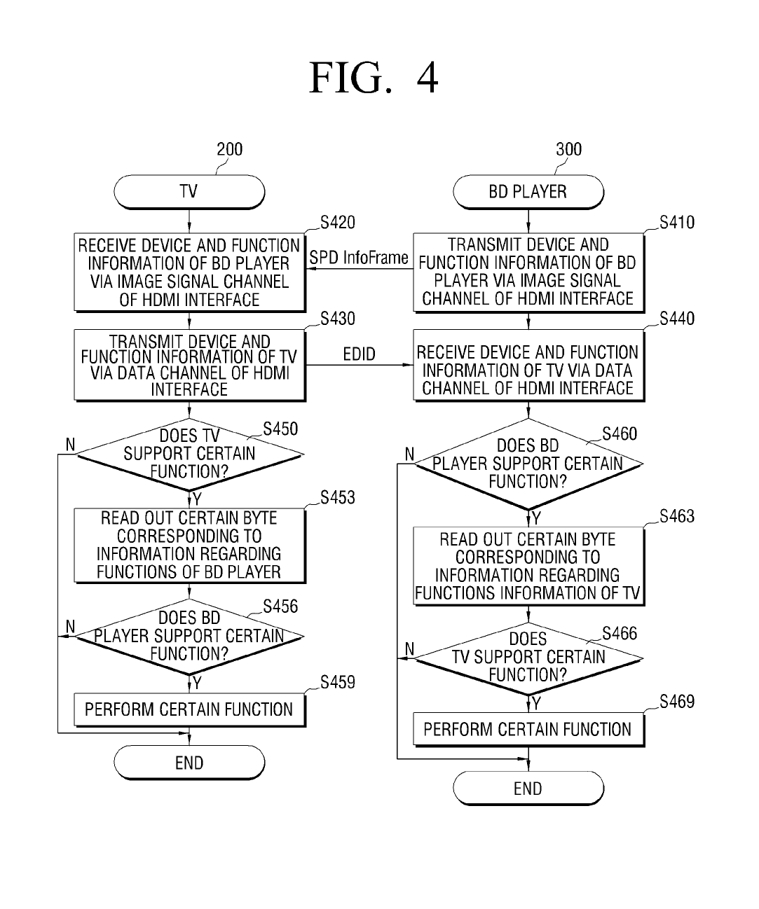

The method of controlling the TV 200 and the BD player 300, which are connectable to each other via the HDMI interface, will be explained with reference to FIG. 4. FIG. 4 is a flow chart provided illustrating a method to control a video apparatus according to an exemplary embodiment of the present general inventive concept.

The operation of the TV 200 is illustrated on the left side and the operation of the BD player 300 is illustrated on the right hand side of FIG. 4.

As for the operation of the TV 200, the TV 200 receives device information and information regarding functions of the BD player 300 from the BD player 300 via an image signal channel of a HDMI interface (S420). The image signal channel may be a TMDS signal channel of the HDMI standards, and device information and information regarding functions of the BD player 300 may be received in a SPD InfoFrame format.

The TV 200 transmits device information and information regarding functions of the TV 200 to the BD player 300 via a data channel of the HDMI interface (S430). The data channel is a DDC of the HDMI standards, and device information and information regarding functions of the TV 200 is transmitted in a EDID format.

The TV 200 determines whether the TV 200 supports certain functions (S450).

If the TV 200 supports certain functions (S450-Y), the TV 200 reads out relevant bytes corresponding to the function information of the BD player 300 from the received SPD InfoFrame (S453). If the function information of the BD player 300 indicates that the BD player 300 supports the certain functions (S456-Y), the TV 200 performs the certain functions (S459).

As for the operation of the BD player 300, the BD player 300 transmits device information and information regarding functions of the BD player 300 to the TV 200 via an image signal channel of the HDMI interface (S410). The image signal channel may be a TMDS signal channel of the HDMI standards, and device information and function information of the BD player 300 may be transmitted in a SPD InfoFrame format.

The BD player 300 receives device information and function information of the TV 200 from the TV 200 via a data channel of the HDMI interface (S440). The data channel may be a DDC of the HDMI standards, and device information and function information of the TV 200 may be received in the EDID format.

The BD player 300 determines whether the BD player 300 supports certain functions (S460). If the BD player 300 supports certain functions (S460-Y), the BD player 300 reads out relevant bytes corresponding to the function information of the TV 200 from the received EDID (S463). If the function information of the TV 200 indicates that the TV 200 supports the certain functions (S466-Y), the BD player 300 performs the certain functions (S469).

Since the TV 200 and the BD player 300 can identify whether certain functions are supported with each other, the TV 200 and the BD player 300 can execute optimum performance together.

The channel of the HDMI interface will be explained with reference to FIG. 5. FIG. 5 is a schematic view illustrating HDMI interface channels in detail according to an exemplary embodiment of the present general inventive concept.

The HDMI interface transmitting terminal 310 and the HDMI interface receiving terminal 260 communicates with each other via an HDMI cable. As illustrated in FIG. 5, the HDMI interface includes a TMDS signal channel 262, DDC 264, consumer electronics control (CEC) 266 channel, and a hot plug detect (HPD) channel and power channel 268.

The transition minimized differential signaling (TMDS) signal channel 262 transmits a video signal, an audio signal, and an InfoFrame from the HDMI interface transmitting terminal 310 to the HDMI interface receiving terminal 260. The InfoFrame includes device information and function information of a device (i.e., the BD player 300) having the HDMI interface transmitting terminal 310.

The display data channel (DDC) is a channel to transmit data regarding encryption and enhanced display identification data (EDID). However the present general inventive concept is not limited thereto.

The CEC 266 channel is a channel to transmit a control signal to control connected devices. The HPD channel 268 is a channel to detect a hot plug. The power channel 268 is a channel to supply power. Among HDMI channels, TMDS signal channel 262 is a one-way communication channel, and DDC, CEC, and HPD channels are two-way communication channels.

Among HDMI interface channels, TMDS signal channel is used to transmit device information and function information of the BD player 300 to the TV 200, and DDC is used to transmit device information and function information of the TV 200 to the BD player 300.

The specification of SPD InforFrame and the location of bytes where function information is recorded will be explained with reference to FIGS. 6 and 7. FIG. 6 is a table illustrating information on data bytes of SPD InfoFrame according to an exemplary embodiment of the present general inventive concept.

As illustrated in FIG. 6, SPD InfoFrame includes a total of 25 bytes, and a vendor name, a model name, and the product group of a device can be recorded in SPD InfoFrame. The 24^{th} data byte can indicate function information.

FIG. 7 is a schematic view illustrating an example of SPD InfoFrame with information regarding BD player functions according to an exemplary embodiment of the present general inventive concept.

As illustrated in FIG. 7, a manufacturer name (a vendor name), “SAMSUNG” and a model name, “BD-P1600”, are recoded in SPD InfoFrame. According to the table in FIG. 6, the product group “0Ah” is “Blu-Ray Disc (BD)”, and the 24^{th} byte 700 indicates function information. The 24^{th} byte 700 may be “0” or “1”, and if it is “0”, that means a certain function is not supported, and if it is “1”, that means a certain function is supported. However the present general inventive concept is not limited thereto.

Other values in addition to “0” and “1” can be used to indicate whether a certain function is supported. One of many values for various functions other than information indicating whether a certain function is supported can be recorded in a byte for function information. The function information can be recorded in other bytes as well as in the 24^{th} byte 700.

As such, device information and function information of the BD player 300 can be recorded using SPD InfoFrame.

The location where information regarding the specification of EDID and function is recorded will be explained with reference to FIGS. 8 and 9. FIG. 8 is a table illustrating information corresponding to EDID bytes according to an exemplary embodiment of the present general inventive concept.

As illustrated in FIG. 8, in EDID, a manufacturer name is recorded in 2 bytes, of which the address is 08h, and a model name is recorded in 2 bytes, of which the address is 0Ah. That is, the byte addresses for a model name are 0Ah and 0Bh. The function information of the TV 200 can be recorded in the address byte of 0Bh. This can be explained with reference to FIG. 9.

FIG. 9 is a schematic view illustrating an example of an EDID having information on television functions.

As illustrated in FIG. 9, the model name “L3” is recorded in data byte A (that is, address 0Ah) of ID product code for the model name. In exemplary embodiments, “0” or “1” is recorded as function information of the TV 200 in data byte B 900 (that is, address 0Bh). If data byte B 900 is “0”, that means the TV 200 does not support a certain function, and if data byte B 900 is “1”, that means the TV 200 supports a certain function.

Other values in addition to “0” and “1” can be used to indicate whether a certain function is supported. One of many values for various functions other than information indicating whether a certain function is supported can be recorded in a byte for function information. The function information can be recorded in other bytes as well as in data byte B 900.

As such, in exemplary embodiments, device information and function information of the TV 200 can be recorded using EDID.

An example of certain functions supported by the TV 200 and the BD player 300 together will be explained. The TV 200 and the BD player 300 may support a BD wise image quality mode as a certain function. In the BD wise image quality mode, the BD player 300 transmits an original image data to the TV 200 and the TV performs image processing on the received image.

If the BD player 300 is set to the BD wise mode, the BD player 300 transmits image data of which image quality is not adjusted to the TV 200 so that the TV 200 may adjust the quality of the image. If the TV 200 is set to the BD wise mode, the TV 200 receives image data of which image quality is not adjusted from the BD player 300 and adjusts the quality of the image. Adjusting image quality means performing image processing. Image mode adjustment includes deinterlacing, upscaling, back light adjustment, contrast, hue, saturation, noise reduction, cadence detection, white balance, resolution, and brightness. However the present general inventive concept is not limited thereto.

A video processing apparatus mounted on the BD player 300 may have less performance than that of the AN processing unit 220 of the TV 200. In this case, if the BD player 300 and the TV 200 execute the BD wise mode, the A/V processing unit 220 of the TV 200 which have better performance performs image data processing, and as a result, a viewer may watch an image with better image quality.

The TV 200 and the BD player 300 may determine whether the BD wise mode is supported with each other by going through the process illustrated above with reference to FIG. 4. If both the TV 200 and the BD player 300 support the BD wise mode, the TV 200 and the BD player 300 may execute the BD wise mode. Accordingly, the TV 200 and the BD player 300 can automatically provide an image with better quality.

Even if the TV 200 and the BD player 300 support the BD wise mode, whether to execute the BD wise mode may be determined depending on whether the function is on or off.

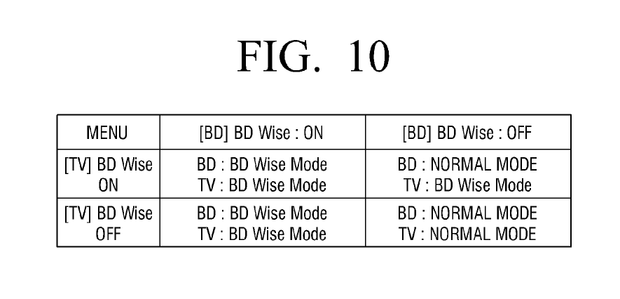

This will be explained with reference to FIG. 10. FIG. 10 is a table illustrating whether a BD wise mode is executed depending on whether a BD wise mode of TV and BD is on or off.

As illustrated in FIG. 10, when the BD wise mode of the BD player 300 is on, both the BD player 300 and the TV 200 execute the BD wise mode. However, if the BD wise mode of the BD player 300 is off, the BD player 300 does not execute the BD wise mode and the TV 200 executes the BD wise mode only when the BD wise mode of the TV 200 is on.

As such, the TV 200 and the BD player 3300 may execute the BD wise mode in various ways, and accordingly a user may view an image with optimum quality. In addition, since the TV 200 and the BD player 300 checks whether the BD wise mode is supported with each other, the TV 200 and the BD player 300 may execute the BD wise mode appropriately without separate manipulation by a user.

In the exemplary embodiment of the present general inventive concept, a video apparatus is the TV 200, but any other video apparatus capable of receiving a HDMI interface, such as a monitor and notebook computer, can also be used.

Video apparatus information is information regarding a video apparatus, and function information of a video apparatus is information regarding functions of a video apparatus.

In exemplary embodiments of the present general inventive concept, the apparatus connected to the video apparatus is the BD player 300, but any other AV apparatuses can also be connected. For instance, other than the BD player 300, a set-top box, blue-ray player, or video player can be connected to the video apparatus. External apparatus information is information regarding apparatuses connected to the video apparatus, and function information of an external apparatus is information regarding functions of external apparatuses connected to the video apparatus.

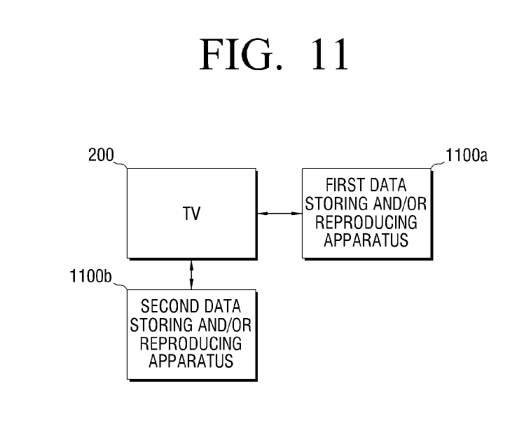

FIG. 11 is a schematic view of a video system according to another exemplary embodiment of the present general inventive concept.

As illustrated shown in FIG. 11, the video system includes a television apparatus (TV) 200, a first data storing and/or reproducing apparatus 1110a, such as a Blue-ray Disk (BD) player 300 of FIG. 1, and a second data storing and/or reproducing apparatus 1110b, such as another BD player 300 of FIG. 1 or data player. In exemplary embodiments, the TV 200 may select at least one of the first data storing and/or reproducing apparatus 1110a or the second data storing and/or reproducing apparatus 1110b to generate image and sound according to signals (data) received from the corresponding data storing and/or reproducing apparatus 1110a and 1110b by using the interface to communicate with the TV 200 as described above.

The present general inventive concept can also be embodied as computer-readable codes on a computer-readable medium. The computer-readable medium can include a computer-readable recording medium and a computer-readable transmission medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although a few exemplary embodiments of the present general inventive concept have been shown and described, it will be appreciated by those skilled in the art that changes may be made in these exemplary embodiments without departing from the principles and spirit of the general inventive concept, the scope of which is defined in the appended claims and their equivalents.

What is claimed is:

1. A video apparatus connectable to an external apparatus, comprising:
an interface connectable to the external apparatus; and
a control unit to transmit apparatus and function information of the video apparatus to the external apparatus and to receive device and function information of the external apparatus,
wherein the function information of the video apparatus includes information regarding whether the video apparatus supports a certain function,
wherein the function information of the external apparatus includes information regarding whether the external apparatus supports a certain function, and
wherein the control unit executes the certain function if the external apparatus and the video apparatus supports the certain function.

2. The video apparatus of claim 1, wherein the certain function includes functions regarding an image quality mode of an image.

3. The video apparatus of claim 1, wherein, according to the certain function, the video apparatus receives data of which an image quality is not adjusted from the external apparatus and adjusts image quality of the image.

4. The video apparatus of claim 2, wherein in the image quality mode, at least one of resolution, sharpness, brightness, noise reduction, hue, and saturation is adjusted.

5. The video apparatus of claim 1, wherein the interface is high definition multimedia interface (HDMI) interface.

6. The video apparatus claim 1, wherein the external apparatus is received in a source product description (SPD) InfoFrame format, and the function information of the external apparatus is included in at least one data byte included in the SPD InfoFrame.

7. The video apparatus of claim 1, wherein the control unit transmits the information of the video apparatus to the external apparatus in a enhanced display identification data (EDID) format and records and transmits the function information of the video apparatus in at least one byte included in the EDID.

8. A method to control a video system in which a video apparatus is connectable to an external apparatus via an interface, the method comprising:
transmitting apparatus and function information of the video apparatus to the external apparatus;
receiving apparatus and function information of the external apparatus; and
executing a certain function if the external apparatus and the video apparatus support the certain function,
wherein the function information of the video apparatus includes information regarding whether the video apparatus supports the certain function, and
wherein the function information of the external apparatus includes information regarding whether the external apparatus supports the certain function.

9. The method of claim 8, wherein the certain function includes a function related to an image quality mode of an image.

10. The method of claim 8, wherein in the executing the certain function, the video apparatus receives data of which image quality mode is not adjusted from the external apparatus and adjusts the image quality mode of the image.

11. The method of claim 9, wherein the image quality mode adjusts at least one of resolution, sharpness, brightness, noise reduction, hue and saturation.

12. The method of claim 8, wherein the receiving receives the information regarding device and function of the external apparatus via an image signal channel of the interface, and
the transmitting transmits information regarding device and function of the video apparatus to the external apparatus via a data channel of the interface.

13. The method of claim 12, wherein the interface is high definition multimedia interface (HDMI).

14. The method of claim 12, wherein the image signal channel is a transition minimized differential signaling (TMDS) of the HDMI interface and the data channel is a display data channel (DDC) of the HDMI interface.

15. An external apparatus connectable to a video apparatus, comprising:
an interface connectable to the video apparatus; and
a control unit to transmit apparatus and function information of the external apparatus to the external apparatus and to receive apparatus and function information of the video apparatus from the video apparatus,
wherein the function information of the external apparatus includes information regarding whether the external apparatus supports a certain function, and the function information of the video apparatus includes information regarding whether the video apparatus supports the certain function, and
wherein the control unit executes the certain function if the external apparatus and the video apparatus support the certain function.

16. The external apparatus of claim 15, wherein the certain function includes a function related to an image quality mode of an image.

17. The external apparatus of claim 15, wherein, according to the certain function, the external apparatus data of which image quality is not adjusted is transmitted to the video apparatus so that the video apparatus can adjust the image quality mode of the image.

18. The external apparatus of claim 16, wherein the image quality mode adjusts at least one of resolution, sharpness, brightness, noise reduction, hue and saturation.

19. A method to control a video system in which an external apparatus is connectable to a video apparatus via an Interface, the method comprising:
transmitting apparatus and function information of the external apparatus to the video apparatus;
receiving apparatus and function information of the video apparatus from the video apparatus; and
executing a certain function if the function information of the video apparatus indicates that the video apparatus supports the certain function and the external apparatus also supports the certain function,
wherein the function information of the external apparatus includes information regarding whether the external apparatus supports the certain function, and
wherein the function information of the video apparatus includes information regarding whether the video apparatus supports the certain function.

20. The method to control an external apparatus of claim 19, wherein the certain function includes a function related to an image quality mode of an image.

21. The method to control an external apparatus of claim 19, wherein in the executing the certain function, the external apparatus transmits data of which an image quality mode is not adjusted to the video external apparatus so that the video apparatus can adjust the image quality mode of the image.

22. The method to control an external apparatus of claim 20, wherein the image quality mode adjusts at least one of resolution, sharpness, brightness, noise reduction, hue and saturation.

23. A video apparatus comprising:
an interface to communicate with an external apparatus; and
a control unit to transmit a first information of the video apparatus to the external apparatus and to receive a second information of the external apparatus,
wherein the control unit executes a certain function if the first information corresponds to the second information.

24. The video apparatus of claim 23, wherein the first information includes a first device information and a first function information of the video apparatus.

25. The video apparatus of claim 24, wherein the second information includes a second device information and a second function information of the external apparatus.

26. The video apparatus of claim 25, wherein the control unit executes the certain function if the first and second function information support the certain function.

27. The video apparatus of claim 23, wherein:
the interface receives and transmits information signals and image data signals through HDMI interface channels;
the information signals comprise the first information and the second information; and
the information signals are transmitted between the image data signals.

28. A computer readable storage medium containing a method of controlling a video apparatus connectable to an external device, the method comprising:
receiving first device information and first function information of the external device;
comparing the first device information and the first function information with a second device information and a second function information of the video apparatus; and
transmitting a signal to the video apparatus to execute a certain function when the first function information and the second function information support the certain function.
